(19) United States
(12) Patent Application Publication
(10) Pub. No.: US 2015/0195775 A1
(43) Pub. Date: Jul. 9, 2015

(54) WLAN RADIOMAP WITH ACCESS POINTS UNIQUELY IDENTIFIED BY COMBINATION OF BSSID AND MCC

(71) Applicants: Lauri Aarne Johannes WIROLA, Tampere (FI); Tommi Antero LAINE, Tampere (FI); Nokia Corporation, Espoo (FI)

(72) Inventors: Lauri Aarne Johannes Wirola, Tampere (FI); Tommi Antero Laine, Tampere (FI)

(21) Appl. No.: 14/419,195

(22) PCT Filed: Aug. 10, 2012
(86) PCT No.: PCT/IB2012/054082

§ 371 Date: Feb. 2, 2015

(51) Int. Cl. H04W 48/16

(52) U.S. Cl. CPC H04W 48/16; H04W 84/12

(57) ABSTRACT

The application relates to storage and retrieval of information about access points APs of wireless local area networks WLANs. It is known to store information about WLAN APs, for example fingerprint data, in such a way that the data can be accessed using the BSSID of the WL-AN AP, i.e. the MAC address of the radio interface, as a key. However, malicious manufacturers or users copy existing MAC addresses and thereby duplicate existing BSSIDs. Effectively this means that the BSSID is not globally unique, but the same BSSID may occur in multiple WLAN APs at multiple locations. Therefore, when using the BSSID as a key, an AP may thus occasionally and incorrectly seem to jump from one location to another. This problem is solved by the present application in that the information about APs (Data) is assigned not only to the BSSID (BSSID1, BSSIDM) as the primary key but also to an identifier of region (MCC1, MCCN), such as the mobile country code MCC, as a secondary key.

### FIELD OF THE DISCLOSURE

The invention relates to the support of the use of information about access points of wireless local area networks, and more specifically to the handling of a storage of information about access points of wireless local area networks and the handling of a retrieval of information about access points of wireless local area networks.

### BACKGROUND

Modern global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points (APs), the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, node positions and/or radio channel models, with base stations of cellular communication networks and access points of WLANs being exemplary nodes. In the end, these refined models may be used for estimating the position of mobile terminals.

Fingerprints do not necessarily have to comprise a GNSS based position. They could also include cellular and/or WLAN measurements only. In this case the fingerprint could be assigned a position for example based on a WLAN based positioning in a server. Such self-positioned fingerprints can be used to learn cellular network information, in case there are cellular measurements in the fingerprint. Moreover, in the set of WLAN measurements in the fingerprint there may be, in addition to measurements for known WLAN access points, also measurements for unknown access points, and the position of the unknown access points can be learned through these self-positioned fingerprints. Finally, more data can be learned for previously known access points based on self-positioned fingerprints.

### SUMMARY OF SOME EMBODIMENTS OF THE INVENTION

For a first aspect, a method is described which comprises receiving an identifier of an access point of a wireless local area network and additional information about the access point. The method further comprises receiving data which enables a determination of an identifier of a region in which the access point is assumed to be located. The method further comprises causing a storage of information that is based on the additional information in a database such that it is assigned to the identifier of the access point as a primary key and to the identity of the region as a secondary key.

For a second aspect, a method is described which comprises receiving an identifier of an access point of a wireless local area network. The method further comprises determining an identifier of a region in which the access point is assumed to be located. The method further comprises retrieving from a database further information about the access point that is stored with an assignment to the identifier of the access point as a primary key and to the identifier of the region as a secondary key.

For the first aspect, moreover a first apparatus is described which comprises means for realizing the actions of the method presented for the first aspect.

For the second aspect, moreover a first apparatus is described which comprises means for realizing the actions of the method presented for the second aspect.

The means of these apparatuses can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

For the first aspect, moreover a second apparatus is described, which comprises at least one processor and at least one memory including computer program code, the at least one memory and the computer program code configured to, with the at least one processor, cause an apparatus at least to perform the actions of the method presented for the first aspect.

For the second aspect, moreover a second apparatus is described, which comprises at least one processor and at least one memory including computer program code, the at least one memory and the computer program code configured to, with the at least one processor, cause an apparatus at least to perform the actions of the method presented for the second aspect.

For the first aspect, moreover a non-transitory computer readable storage medium is described, in which computer program code is stored. The computer program code causes an apparatus to perform the actions of the method presented for the first aspect when executed by a processor.

For the second aspect, moreover a non-transitory computer readable storage medium is described, in which computer program code is stored. The computer program code causes an apparatus to perform the actions of the method presented for the second aspect when executed by a processor.

For both aspects, the computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood for both aspects that also the respective computer program code by itself has to be considered an embodiment of the invention.

For a third aspect, a non-transitory computer readable storage medium is described, in which a database is stored, the database being configured to have a structure which enables a storage of identifiers of access points of wireless local area networks as primary keys and, assigned to a respective identifier of an access point, an identifier of one or more regions as a respective secondary key and, assigned to a respective identifier of a region, further information about an access point of a wireless local area network, the access point being assumed to be located in the region. The computer readable storage medium could be again for example a disk or a memory or the like. An apparatus comprising the presented computer readable storage medium may equally be an exemplary embodiment of the third aspect.

Moreover a system is described, which comprises any apparatus as presented for the first aspect and/or any apparatus as presented for the second aspect, and in addition a non-transitory computer readable storage medium storing a database, as presented for the third aspect. If the comprised apparatus is a mobile device, the system could optionally comprise in addition a server. If the comprised apparatus is a server, the system could optionally comprise in addition a mobile device.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described methods are information providing methods, and the described first apparatuses are information providing apparatuses. In one embodiment, the means of the described first apparatuses are processing means.

In certain embodiments of the described methods, the methods are methods for supporting the use of information about access points of wireless local area networks. In certain embodiments of the described apparatuses, the apparatuses are apparatuses for supporting the use of information about access points of wireless local area networks.

It is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of an apparatus according to the first aspect;

FIG. 2 is a flow chart illustrating an exemplary embodiment of a method according to the first aspect;

FIG. 3 is a schematic block diagram of an exemplary embodiment of an apparatus according to the second aspect;

FIG. 4 is a flow chart illustrating an exemplary embodiment of a method according to the second aspect;

FIG. 5 is a schematic block diagram of an exemplary system;

FIG. 6 is a flow chart illustrating an exemplary first operation in the system of FIG. 5;

FIG. 7 is a diagram illustrating the structure of an exemplary database; and

FIG. 8 is a flow chart illustrating an exemplary second operation in the system of FIG. 5.

### DETAILED DESCRIPTION OF THE FIGURES

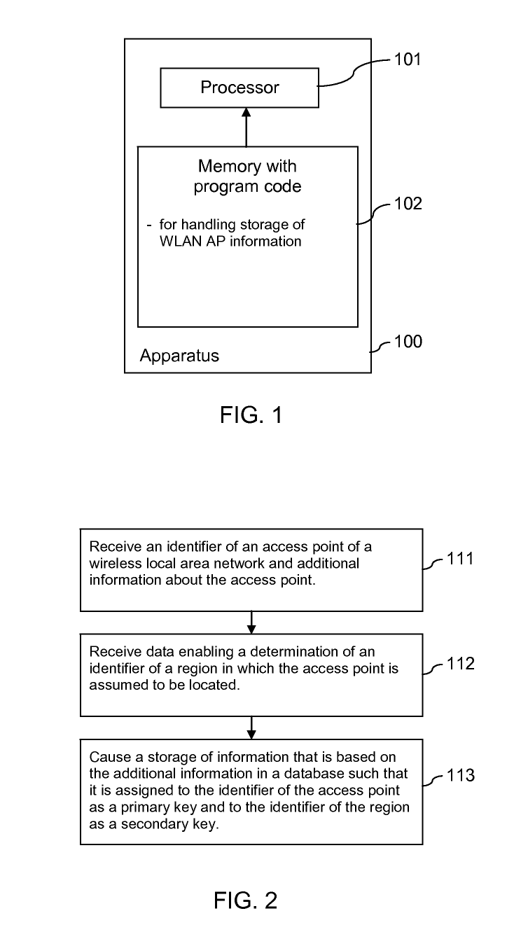

FIG. 1 is a schematic block diagram of an exemplary apparatus 100. Apparatus 100 comprises a processor 101 and, linked to processor 101, a memory 102. Memory 102 stores computer program code for supporting the use of information about access points of WLAN, and more specifically for handling a storage of information about WLAN access points. Processor 101 is configured to execute computer program code stored in memory 102 in order to cause an apparatus to perform desired actions.

Apparatus 100 could be a server or any other device, for instance a mobile device. Such a mobile device could be for example a communication terminal, like a mobile phone, a smart phone, a laptop, a tablet computer, etc. Apparatus 100 could equally be a module, like a chip, circuitry on a chip or a plug-in board, for a server or for any other device. Apparatus 100 is an exemplary embodiment of any apparatus according to the presented first aspect. Optionally, apparatus 100 could comprise various other components, like a data interface, a user interface, a further memory, a further processor, etc.

An operation of apparatus 100 will now be described with reference to the flow chart of FIG. 2. The operation is an exemplary embodiment of a method according to the presented first aspect. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus receives an identifier of an access point of a wireless local area network and additional information about the access point. (action 111)

The apparatus receives in addition data enabling a determination of an identifier of a region in which the access point is assumed to be located. (action 112)

The apparatus causes a storage of information that is based on the additional information in a database such that it is assigned to the identifier of the access point as a primary key and to the identifier of the region as a secondary key. (action 113) The information that is based on the additional information can be identical to the additional information, or it may be a refined or otherwise modified version of the additional information.

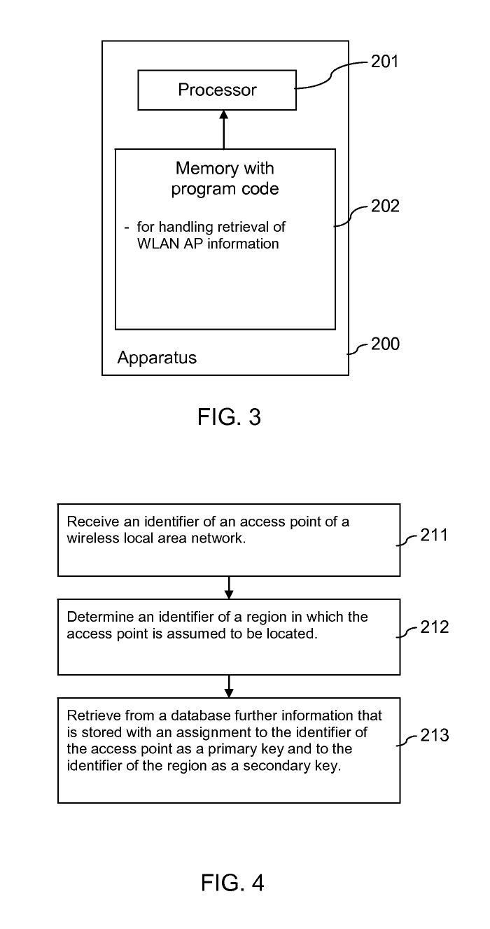

FIG. 3 is a schematic block diagram of another exemplary apparatus 200. Apparatus 200 comprises a processor 201 and, linked to processor 201, a memory 202. Memory 202 stores computer program code for supporting the use of information about access points of wireless local area networks, and more specifically for handling a retrieval of information about WLAN access points. Processor 201 is configured to execute computer program code stored in memory 202 in order to cause an apparatus to perform desired actions.

Apparatus 200 could be a server or any other device, for instance a mobile device. Such a mobile device could be for example a communication terminal, like a mobile phone, a smart phone, a laptop, a tablet computer, etc. Apparatus 200 could equally be a module, like a chip, circuitry on a chip or a plug-in board, for a server or for any other device. Apparatus 200 is an exemplary embodiment of any apparatus according to the presented second aspect. Optionally, apparatus 200 could have various other components, like a data interface, a user interface, a further memory, a further processor, etc.

An operation of apparatus 200 will now be described with reference to the flow chart of FIG. 4. The operation is an exemplary embodiment of a method according to the presented second aspect. Processor 201 and the program code stored in memory 202 cause an apparatus to perform the operation when the program code is retrieved from memory 202 and executed by processor 201. The apparatus that is caused to perform the operation can be apparatus 200 or some other apparatus, in particular a device comprising apparatus 200.

The apparatus receives an identifier of an access point of a wireless local area network. (action 211)

The apparatus furthermore determines an identifier of a region in which the access point is assumed to be located. (action 212)

The apparatus furthermore retrieves from a database further information about the access point that is stored with an assignment to the identifier of the access point as a primary key and to the identifier of the region as a secondary key. (action 213)

A database storing information about WLAN access points, for example fingerprint data or model data that has been determined based on fingerprint data, could be structured such that the data can be accessed using the BSSID of the WLAN access point, that is, the MAC address of the radio interface, as a key. The BSSID address space currently comprises 48 bits (MAC-48 [obsolete term], or EUI-48). The 48 bits are partitioned into 24 MSBs (most significant bits) for the manufacturer identification and 24 LSBs (least significant bits) for manufacturer's use. The newer MAC address space EUI-64 comprises 64 bits also has 24 bits reserved for the manufacturer identification.

With 24 bits for manufacturer's use in the address space EUI-48, each manufacturer can assign different addresses to 16 million access points only, and may thus run out of address space. Malicious manufacturers or users could furthermore copy existing MAC addresses and thereby duplicate existing BSSIDs. Effectively this means that the BSSID is not globally unique, but the same BSSID may occur in multiple WLAN access points at multiple locations.

When indexing a database, which comprises information about WLAN access points, using the BSSID, an access point may thus occasionally (and incorrectly) seem to jump from one location to another when considering incoming learning data for supplementing and/or updating the database. Eventually it may even be erroneously deduced that the WLAN access point is a moving access point.

Certain embodiments of the presented first aspect therefore provide that an apparatus may cause a storage of information about a WLAN access point with a mapping to an identifier of the access point as a primary key or index, and to an identifier of a region as a secondary key or index.

Certain embodiments of the presented second aspect provide in a complementary manner that an apparatus may retrieve information about a WLAN access point that is stored with a mapping to an identifier of an access point as a primary key or index, and to an identifier of a region as a secondary key or index. The identifier of the WLAN access point may be received as an input at the apparatus. The identifier of the region may be determined by the apparatus either based on received data or based on data stored in the database or elsewhere.

Certain embodiments of the presented third aspect provide a computer readable medium storing a database, which has a structure that may be suited to be used by embodiments of the first and second aspect.

Each of the first, second and third aspect may thus enable an easy and intuitive way of handling multiple access points having the same identifier. If the identifier of an access point is not unique, an additional criterion is checked for ensuring that information can be retrieved correctly. Using an identifier of a region as this additional criterion may have the effect that it may consume little storage space. The SSID, for instance, that may be used by a user for defining additional identity information for an access point, is a 32-byte field. If the SSID was used as an alternative additional criterion, storage of the contained information in a database would use up much storage space. Furthermore, an identifier of a region is public information that does not raise any privacy problems, as the use of the SSID as a user-set field might.

In this text, any receiving of data or information by an apparatus may refer, for example, to receiving the data from another apparatus of another device, to receiving the data from another apparatus in the same device, to receiving the data from another component of the same apparatus and/or to receiving the data within the apparatus by the execution of a piece of program code, etc.

A region in which the access point is assumed to be located may optionally and/or in some cases be a region in which the access point is known to be located.

Apparatus 100 illustrated in FIG. 1 and the method illustrated in FIG. 2 may be implemented and refined in various ways. Apparatus 200 illustrated in FIG. 3 and the method illustrated in FIG. 4 may equally be implemented and refined in various ways. The functions of apparatus 100 and apparatus 200 could also be combined in a single apparatus. In this case, the program code in memory 202 and in memory 102 could also be stored in a single memory. The database structure of the presented third aspect could equally be implemented and refined in various ways, and the computer readable medium storing the database could be combined in exemplary embodiments with functions of apparatus 100 and/or functions of apparatus 200 in a single device.

In an exemplary embodiment of all presented aspects, the identifier of the access point comprises a basic service set identification.

In an exemplary embodiment of all presented aspects, a region may be a country and the identifier of a region may comprise a mobile country code. This may have the effect that an existing definition may be reused and that the required information may be available in many cases, in particular if the information about the access point is obtained by crowd-sourcing.

A mobile country code (MCC) is used together with a mobile network code (MNC) for uniquely identifying a mobile communication network. It comprises three digits. To most countries, a single code is assigned. The code ‘244’ is assigned for instance to Finland. To a few countries, several codes are assigned. The codes ‘404’, ‘405’ and ‘406’ are assigned for instance to India. The mobile country code can be included in signals transmitted by nodes of a cellular communication network. In a global system for mobile communications (GSM), in a wide-band code division multiple access (WCDMA) system, in a time division synchronous CDMA (TD-SCDMA) system and in a long term evolution (LTE) system, for instance, the MCC/MNC pair forms the public land mobile network (PLMN) identification as a part of the global cell identification (GCI).

It is to be understood, however, that any other kind of regions and associated identifiers could be used just the same. For instance, the surface of Earth could be divided into regions, that are defined by a respective left lower corner having integer longitude and latitude coordinates of a geographic coordinate system, etc. The identifier could then correspond to the combination of integer longitude and latitude coordinates, or to some number assigned to each region.

The data that enables determination of an identifier of a region may enable such determination in different ways. The data may be for instance data that comprises the identifier, or it may be for instance data that enables a conversion into the required identifier, or it may be for instance data that enables a determination of the identifier when considered together with other data, for example stored data that can be accessed by the apparatus.

In an exemplary embodiment of the first aspects, the identifier of the region is determined based on a mobile country code, which is received, by the apparatus, from a mobile device, for instance along with data on which the additional information about the access point is based. In another exemplary embodiment of the first aspects, the identifier of the region is determined based on a mobile country code, which is received at the apparatus from a database along with data on which the additional information about the access point is based. Using a received mobile country code as an identifier may have the effect that the identifier is readily available and that no further processing is required. In another exemplary embodiment of the first aspect, the identifier of the region is determined based on an indication of a position of a mobile device, which is received at the apparatus from a mobile device along with data on which the additional information about the access point is based. In another exemplary embodiment of the first aspect, the identifier of the region is determined based on an indication of a position, which is received, by the apparatus, from a database along with data on which the additional information about the access point is based. Using a position as a basis for an identifier of a region may have the effect that an identifier, like a mobile country code, may be used even if the identifier as such is not available at first. For instance, a mobile device providing data might perform only WLAN scans and no cellular measurements, and the observed WLANs might not provide any indication of an identifier of a region, like a mobile country code. In each of these embodiments, the data could be for instance fingerprint data and/or parameters of a refined model for the access point and the additional information could be for instance fingerprint data and/or parameters of a refined model for the access point.

An exemplary embodiment of the first aspect may take account of a situation in which the database comprises previously stored information about an access point, which is assigned to the received identifier of an access point as a primary key but only to a different identifier of a region as a secondary key than would be determined in a first step for the received additional information about an access point based on the received data. In case the previously stored information about an access point comprises location information that identifies a location within a predetermined distance to a location of an access point indicated in the received additional information, information that is based on the received additional information could be combined with the previously stored information, and the combined information could be stored such that it is assigned to one of the identifiers of a region as a secondary key, or such that it is assigned to each of the identifiers of a region as a secondary key in parallel. Otherwise, information that is based on the received additional information could be stored separately such that it is assigned to the received identifier of the access point as a primary key and to the identifier of a region, which is determined based on received data, as a secondary key. This may take account of WLANs located at a border between two regions, with the coverage area of the WLAN access point reaching across the border, or with the identifier of the region being occasionally wrongly determined at a location close to the border. The predetermined distance could be of any desired value, for instance 20 meters, 100 meters or 500 meters. Assigning combined information in parallel to two secondary keys may have the effect that the complete set of information will be available when accessing the database using any of the identifiers as secondary keys.

In an exemplary embodiment of the second aspect, the identifier of an access point could be received at the apparatus for example from a mobile device, for which a positioning is to be performed based on a WLAN scan, or for which refined model data for WLAN access points is to be assembled. Alternatively, it could be received for instance from a server intending to generate refined model data for particular WLAN access points.

In an exemplary embodiment of the second aspect, the identifier of the region may be determined based on at least one mobile country code, and it could be for instance equal to a mobile country code. In an exemplary embodiment of the second aspect, the identifier of the region may be determined based on an identifier of a region, for instance a mobile country code, that has been obtained at a mobile device in cellular measurements and that is received by the apparatus. In an exemplary embodiment of the second aspect, the identifier of the region may be determined based on an identifier of a region, for instance a mobile country code, that has been obtained at a mobile device from signals from an access point of a wireless local area network and that is received by the apparatus. Using at the apparatus such an identifier of a region that is provided by a mobile device may have the effect that the identifier may be available without additional processing load and that the assumption on the region may be particularly reliable. In an exemplary embodiment of the second aspect, the identifier of the region may be determined by evaluating identifiers of regions that are available as secondary keys in the database. This may have the effect that an identifier of a region may be determined even if not provided by a mobile device.

In an exemplary embodiment of all aspects, the information that is based on the additional information—or the further information—about the access point may comprise coordinates of at least one location at which signals from the access point can be received and/or results of signal strength measurements on signals from the access point. Such data may be fingerprint data collected by a mobile device or a plurality of mobile devices. The information could also be data for a signal strength grid (Rx grid). Each grid point of such a grid could correspond to a real location, and the result of signal strength measurements at various locations could be assigned to a corresponding grid point. In an exemplary embodiment of all aspects, the information about the access point may comprise model data for the access point. In an exemplary embodiment of all aspects, the information about the access point may comprise data indicating coordinates of the access point, data indicating a coverage area of the access point, and/or parameters of a radio propagation model for the access point. Such data may be model data that has been computed based on fingerprint data collected by mobile devices.

The information that is retrieved according to the second aspect may be provided for instance for supporting a positioning of a mobile device or for generating a refined model for the access point.

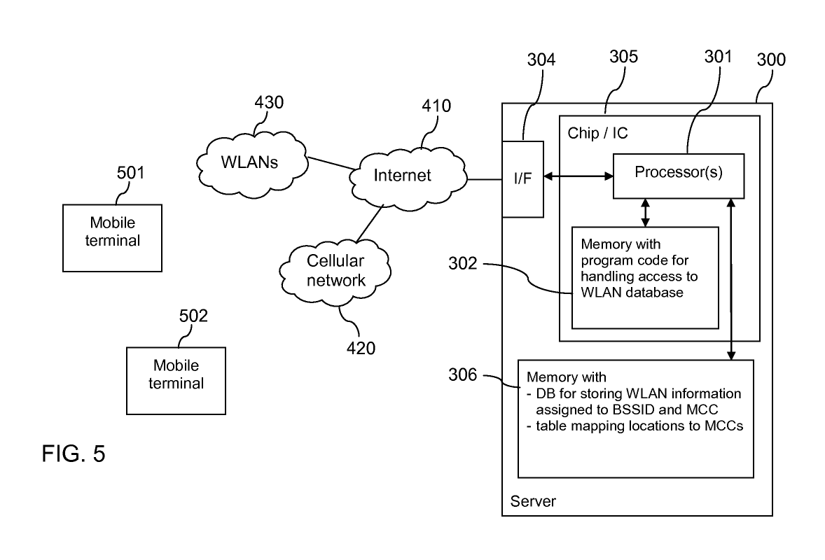

FIG. 5 is a schematic block diagram of an exemplary system, which supports the use of information about WLAN access points for a positioning of mobile devices. The system and its operation may comprise embodiments of the first, second and third aspect.

The system comprises a server 300. Server 300 is connected to a network 410, for example the Internet. Server 300 could also belong to network 410. Network 410 is suited to interconnect server 300 with mobile terminals 501, 502 via a cellular network 420 and/or via WLANs 430.

Server 300 may be for instance a dedicated positioning server, a position data learning server, or some other kind of server. It comprises a processor 301 that is linked to a first memory 302, to a second memory 306 and to an interface (I/F) 304. Processor 301 is configured to execute computer program code, including computer program code stored in memory 302, in order to cause server 300 to perform desired actions.

Memory 302 stores computer program code for handling an access to a WLAN database. The computer program codes may comprise for example similar program codes as memory 102 and memory 202. The program codes could belong for instance to a comprehensive application supporting a learning of position data and/or supporting a positioning of mobile terminals. In addition, memory 302 may store computer program code implemented to realize other functions, as well as any kind of other data. It is to be understood, though, that program code for any other actions than for handling an access to a WLAN database could also be implemented on one or more other physical and/or virtual servers or on a mobile terminal. It is further to be understood that the computer program code for handling an access to a WLAN database could comprise first computer program code for storing WLAN data in a database and second computer program code for retrieving WLAN data from a database, and that either the first or the second computer program code could be stored and executed on a different device.

Processor 301 and memory 302 may optionally belong to a chip or an integrated circuit 305, which may comprise in addition various other components, for instance a further processor or memory.

Memory 306 stores a database that can be accessed by processor 301. The database is configured to store WLAN data. In addition, memory 306 could store other data, for instance a table mapping locations to mobile country codes or further data supporting a positioning of mobile terminals. It is to be understood that a memory storing the database could also be external to server 300; it could be for instance on another physical or virtual server.

Interface 304 is a component which enables server 300 to communicate with other devices, like mobile terminals 501 and 502, via network 410. Interface 304 could comprise for instance a TCP/IP socket.

Component 305 or server 300 could correspond to exemplary embodiments of an apparatus according to the presented first and second aspect, and memory 306 could correspond to exemplary embodiment of a computer readable medium according to the presented third aspect.

The cellular communication network 420 could be based on any kind of cellular system, for instance a GSM system, a 3rd Generation Partnership Project (3GPP) based cellular system like a WCDMA system or a TD-SCDMA system, a 3GPP2 system like a CDMA2000 system, a LTE or LTE-Advanced system, or any other type of cellular system, like a worldwide interoperability for microwave access (WiMAX) system.

Each of the WLANs 430 comprises at least one access point. To each access point, a BSSID has been assigned.

Mobile terminal 501 is configured to perform WLAN scans for detecting signals from WLAN access points and to observe signals from transceivers of cellular network 420. Mobile terminal 501 further comprises a global positioning system (GPS) receiver as an exemplary GNSS receiver and is configured to determine its position using signals received by the GPS receiver.

Mobile terminal 502 is configured to perform WLAN scans for detecting signals from WLAN access points and to observe signals from transceivers of cellular network 420.

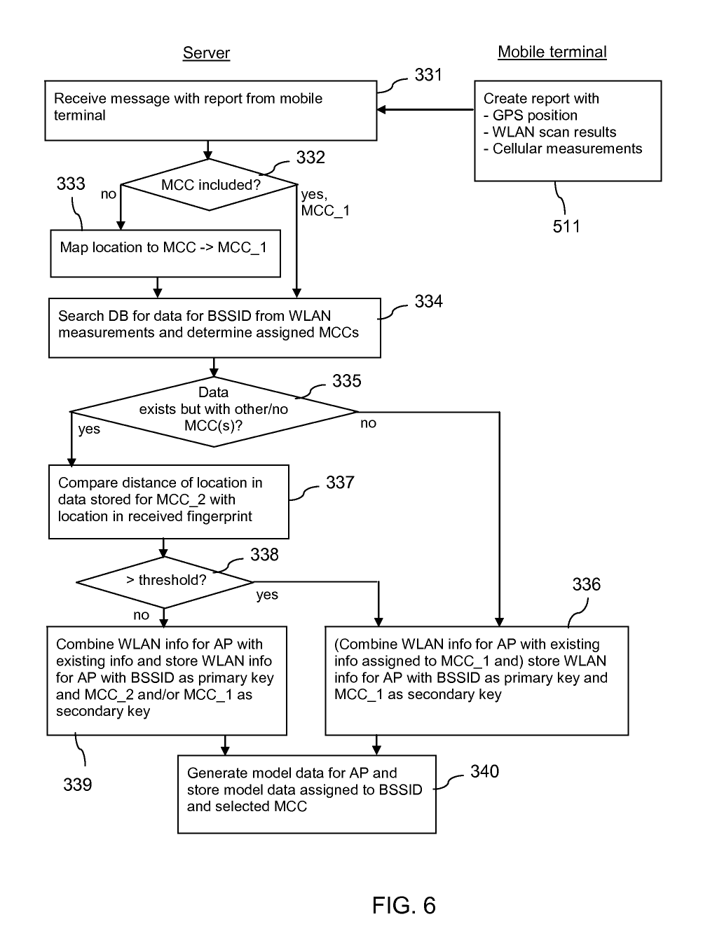

An exemplary first operation in the system of FIG. 5 will now be described with reference to the flow chart of FIG. 6. The exemplary first operation relates to the storage of WLAN data in a database.

Operations at mobile terminal 501 are presented on the upper right hand side of FIG. 6. Otherwise, FIG. 6 presents the operations at server 300. Processor 301 and some of the program code stored in memory 302 cause server 300 to perform the presented operations when the program code is retrieved from memory 302 and executed by processor 301.

Mobile terminal 501 and other mobile terminals create at regular intervals a report with fingerprint data. (action 511) The report may include a position of mobile terminal 501 that has been determined based on GPS signals. The report may include results of a WLAN scan, that is, results of the evaluation of signals transmitted by WLAN access points that are received at a current location of mobile terminal 501. The results of the WLAN scan may include for all WLAN access points, from which signals can be observed at the indicated position, the BSSID as the MAC address of the access point and, optionally, the SSID assigned by a user to the access point and/or the signal strength of observed signals at the indicated position and/or other information. If provided by the WLAN access point, the results of the WLAN scan may include in addition a mobile country code. The report may further include a cellular measurement report with results of measurements on observed cells of cellular network 420. A current serving cell for mobile terminal 501 is identified in a cellular measurement report of mobile terminal 501 by its GCI, including the MCC. The entire report is transmitted by mobile terminal 501 to server 300 in a message via cellular network 420 and the Internet 410 or via a WLAN 430 and the Internet 410.

Server 300 receives the message with the report from mobile terminal 501. (action 331)

Server 300 then determines whether an MCC is included in the report. (action 332) The MCC may be included in the report in the scope of the results of cellular measurements, and it will be referred to as mobile country code MCC_1. In case the MCC belongs to a country to which a plurality of MCCs are assigned, a predetermined MCC for this country may be selected as relevant mobile country code MCC_1 so that only a single MCC per country is considered.

If the report does not include an MCC, server 300 maps the GPS based location from the report to an MCC as mobile country code MCC_1. (action 333) This can be achieved for instance using a mapping table stored in memory 306.

Server 300 then determines at least one BSSID from the report. The following actions 334 to 339 can be performed for each BSSID in the report, in case there are multiple BSSIDs in the report.

Server 300 searches the WLAN database in memory 306 using the determined BSSID as a primary key. If the BSSID is found, server 300 determines in addition the MCCs that are assigned to the BSSID as secondary keys. (action 334)

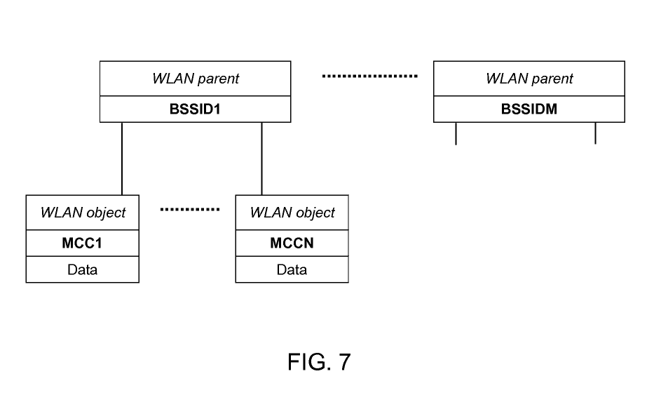

The structure of the database is illustrated in FIG. 7. There is a WLAN parent for each BSSID, for instance 1st to Mth BSSID, with M being a variable natural number. The BSSID is the primary key based on which the database can be searched. In addition, there can be one or more WLAN objects for each WLAN parent. Each WLAN object is identified by an MCC, for instance 1st to Nth MCC with N being a variable natural number that is moreover determined separately for each WLAN parent. The MCC of the WLAN objects is the secondary key based on which the database can be searched within each WLAN parent. Information about an access point, which has the BSSID of the WLAN parent and which is located in a country identified by the MCC of a WLAN object, is stored as data in the WLAN object. Such data could comprise for instance coordinates of one or more locations. It could further comprise signal strength measurements associated with the locations and/or any other information on the access point.

The structure illustrated in FIG. 7 represents an exemplary embodiment of the third aspect. The non-transitory computer readable storage medium storing the database configured to have the represented structure could correspond to memory 306. The BSSIDs could correspond to identifiers of access points of wireless local area networks as primary keys. The MCCs, which are assigned to a respective BSSID of a particular WLAN parent, could correspond to an identifier of one or more regions as secondary keys. The data of a WLAN object, which is assigned to a respective MCC of a particular WLAN object, could correspond to further information about an access point of a wireless local area network, the access point being assumed to be located in the region.

In case server 300 determines that there is no WLAN parent for the BSSID received in the report so far (action 335), server 300 creates a new WLAN parent with the BSSID as a primary key and a new WLAN object with the determined MCC_1 as a secondary key, and stores information about the WLAN access point in the received report in this new WLAN object. (action 336) The information that is stored could comprise for instance the GPS location included in the report. It could further comprise signal strength measurements for this location and/or any other information on the access point that may be included in the report. The information that is stored could be modified compared to the information that is received in action 331.

In case server 300 determines that the database already comprises a WLAN parent for the BSSID received in the report and that this WLAN parent has a WLAN object for the determined MCC_1 (action 335), server 300 combines information about the WLAN access point in the received report with the stored data in the found WLAN object, and stores the combined information as new data for this WLAN object. (action 336) The information about the WLAN access point in the received report may be modified before it is combined with the stored information.

In case server 300 determines that there is a WLAN parent for the BSSID received in the report, but only with a WLAN object for at least one other MCC, referred to as mobile country code MCC_2, than the determined mobile country code MCC_1 (action 335), server 300 determines whether any of the stored data can be assumed to belong nevertheless to the same WLAN access point, for which data has been received in the report. To this end, server 300 determines the distance between the GPS location in the report with one or more locations indicated in the data that is stored in the WLAN object identified by the secondary key MCC_2. The locations in the stored data may correspond to GPS based locations received in previous reports. (action 337)

If any of the determined distances does not exceed a predetermined threshold value, for instance 100 meters (action 338), server 300 assumes that the WLAN object comprises information about the same access point as the information in the received report. This can be the case, if the WLAN access point is located close to the border between two countries with assigned mobile country codes MCC_1 and MCC_2, respectively, so that a mobile terminal 501 receiving signals from the WLAN access points may be connected to the network of an operator of either country. In this case, server 300 combines the information about the WLAN access point in the received report with the stored data in the found WLAN object and stores the combined information as new data for this existing WLAN object identified by secondary key MCC_2. (action 339)

It has to be noted that it could be monitored, for instance by means of counters, how often the data of this existing WLAN object identified by secondary key MCC_2 is combined with received information for which MCC_1 or MCC_2 is determined as MCC. If information for mobile country code MCC_1 is received and combined more frequently with the existing data, the identification of the WLAN object could be changed from secondary key MCC_2 to secondary key MCC_1, in order to reduce the processing load at server 300.

Alternatively, the secondary key identifying the WLAN object could also be changed on a general basis to the new mobile country code MCC_1 when storing the combined data.

Further alternatively, a new WLAN object identified by secondary key MCC_1 could be created for the WLAN parent, and the combined information could be stored as new data for the existing WLAN object identified by secondary key MCC_2 and in addition as data for the new WLAN object identified by secondary key MCC_1. Both objects would thus have the same data.

With any of these alternatives, the information about the WLAN access point in the received report may be modified before it is combined with the stored information.

If, in contrast, each of the determined distances exceeds the predetermined threshold value (action 338), server 300 creates for the existing WLAN parent a new WLAN object for the determined mobile country code MCC_1, and stores information about the WLAN access point in the received report as data of this new WLAN object. (action 336) Again, the information that is stored could be modified compared to the information that is received in action 331.

Occasionally or upon request or each time the fingerprint data has been updated, the stored fingerprint data could be used for generating refined model data for all or selected access points. (action 340) Such model data could comprise for instance a location of the access point, estimated as the average of GPS locations that have been stored as information about the access point and that indicate from which locations reports have been received for this access point. Such model data could comprise for instance parameters defining a coverage area of the access point, estimated based on GPS locations that have been stored as information about the access point and that indicate from which locations reports have been received for this access point. Such model data could comprise for instance parameters of a radio propagation model determined based on signal strength measurements that have been stored as information about the access point. Such a radio propagation model may predict for each location the expected signal strength of signals transmitted by the WLAN access point. The data for a model for an access point may be stored in a database in the same memory 306 or in a different memory at server 300 or at another device, for instance at a mobile terminal requesting the data. The model data can be stored again such that it is assigned to a BSSID as a primary key and to an MCC as a secondary key.

Thus, actions 331 to 339 can be an embodiment of a storage of information about a WLAN access point according to the first aspect, and action 340 can equally be an embodiment of a storage of information about a WLAN access point according to the first aspect.

It is to be understood that all or a part of actions 332 to 340 could also be realized at mobile terminal 501, for instance if mobile terminal 501 collects and stores fingerprints before sending the collected data to a server.

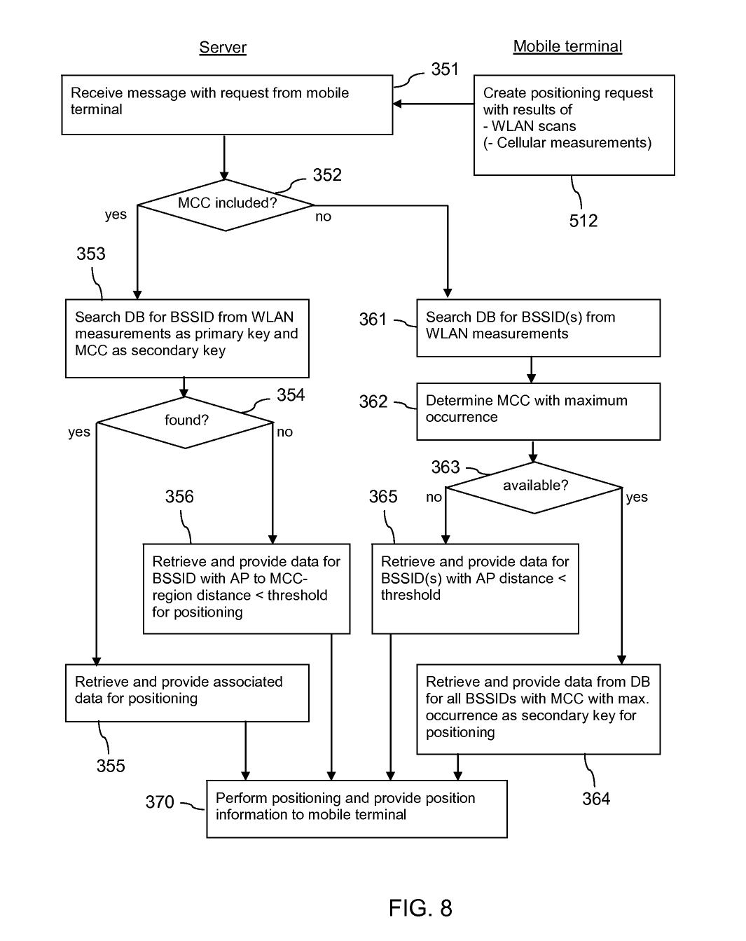

An exemplary second operation in the system of FIG. 5 will now be described with reference to the flow chart of FIG. 8. The exemplary second operation relates to the retrieval of WLAN data from a database.

Operations at mobile terminal 502 are presented on the upper right hand side of FIG. 8. Otherwise, FIG. 8 presents the operations at server 300. Processor 301 and some of the program code stored in memory 302 cause server 300 to perform the presented operations when the program code is retrieved from memory 302 and executed by processor 301.

Mobile terminal 502 may perform a WLAN scan and create a positioning request for its current location. (action 512) The request may include results of the WLAN scan. The results of the WLAN scan may include for all WLAN access points, from which signals can be observed at a current location, the BSSID as the MAC address of the access point and, optionally, the SSID assigned by a user to the access point and the signal strength of observed signals and any other obtained information. The request may further include results of cellular measurements on observed cells. A current serving cell of mobile terminal 502 is identified in a cellular measurement report by its GCI, including the MCC. The request is transmitted by mobile terminal 502 to server 300 in a message via cellular network 420 and the Internet 410 or via a WLAN 430 and the Internet 410.

Server 300 receives the message from mobile terminal 502. (action 351)

Server 300 determines whether an indication of an MCC is included in the request. (action 352) Server 300 moreover determines at least one BSSID from the request.

If an indication of an MCC is included in the request, server 300 searches a database in memory 306 for a WLAN parent identified by a BSSID indicated in the request and for WLAN objects of the WLAN parent identified by the MCC indicated in the request. (action 353) The BSSID is thus used as a primary key and the MCC is used as a secondary key. The searched database can be a database with fingerprint data or a database with refined model data.

For example, the MCC from cellular measurement results in the request could be MCC_2, while the database could comprise for the BSSID in the request as a primary key a WLAN parent with a first WLAN object identified by MCC_1 as secondary key and a second WLAN object identified by MCC_2 as secondary key. In this case, a match is found with the second WLAN object identified by MCC_2. On the other hand, the MCC from cellular measurement results in the request could be MCC_2, while the database could comprise for the BSSID in the request a WLAN parent with a single WLAN object identified by MCC_1. In this case, no match is found.

If a match is found (action 354), server 300 retrieves stored information about the access point from the corresponding WLAN object and provides it for a positioning of mobile terminal 502. (action 355)

If no match is found (action 354), but a WLAN parent for the correct BSSID is found in the database, server 300 may determine whether information about the correct access point could be available nevertheless. Server 300 could determine to this end whether any location indicated in any of the WLAN objects that are assigned to the WLAN parent has a distance to a region defined by the received MCC that falls short of a predetermined threshold value. If this is the case, the WLAN object is considered to comprise information about an access point close to a border between countries, and the data of the WLAN object is retrieved and provided for a positioning of mobile terminal 502. (action 356) The predetermined threshold value can be for example 100 meters, but it could have any other value as well.

Actions 353 to 356 can be performed separately for each BSSID in the request, in case there are multiple BSSIDs in the request.

If it is determined that the request from mobile terminal 502 does not include an indication of an MCC (action 352), server 300 searches a database in memory 306 for all WLAN parents identified by one of the BSSIDs indicated in the request, the BSSIDs thus being again primary keys. (action 361) The searched database can be again a database with fingerprint data or a database with refined model data.

If no WLAN parent is found for a BSSID, no data is available for this BSSID. If a WLAN parent is found for at least one BSSID in the request, server 300 determines the WLAN objects and the corresponding MCCs for all found WLAN parents. Furthermore, server 300 determines the MCC which identifies most WLAN objects of all found WLAN parents, and which is thus the most frequently used secondary key for a given set of primary keys. (action 362) For instance, if the request of mobile terminal 502 comprises a first BSSID, BSSID_1, and a second BSSID, BSSID2, server 300 may determine that the database stores a WLAN parent for both. The WLAN parent for BSSID_1 may further comprise two WLAN objects identified by MCC_1 and MCC_2, respectively. The WLAN parent for BSSID_2 may further comprise a single WLAN object identified by MCC_1. Thus, MCC_1 is the secondary key occurring most often, namely twice, for the group of primary keys BSSID_1 and BSSID_2. It is to be understood that if only a single WLAN parent with a single WLAN object is found, a secondary key occurring most often could also be the MCC identifying this single WLAN object.

If a secondary key MCC_1 occurring most often is available (action 363), server 300 retrieves from the database the data of all WLAN objects identified by MCC_1 of all WLAN parent identified by those BSSIDs that are included in the request. The data is provided for a positioning of mobile terminal 502. (action 364)

If a secondary key occurring most often is not available for found WLAN parents (action 363), server 300 may determine whether suitable data is available nevertheless. For instance, the request could indicate two BSSIDS, BSSID_1 and BSSID2, and there could be WLAN parents identified by BSSID_1 and BSSID_2 as primary keys in the database, the WLAN parent identified by BSSID_1 having one WLAN object identified by MCC_1 and the WLAN parent identified by BSSID_2 having one WLAN object identified by MCC_2. Server 300 may then determine whether WLAN objects in different found WLAN parents comprise an indication of locations that have a distance to each other which falls short of a predetermined threshold value. The predetermined threshold value can be again 100 meters or any other value. In this case, the data can be considered to belong to the same WLAN access point, and the data is retrieved and provided for a positioning of mobile terminal 502. (action 365)

It has to be noted that this situation may not arise in case data for close WLAN access points with the same BSSID is combined when creating the entries of the database, as described with reference to FIG. 6. In this case, action 365 could be omitted.

The information that is provided for positioning of mobile terminal 502 in actions 355, 356, 364 or 365 may be used by server 300 for determining the position of mobile terminal 502. If the retrieved data is fingerprint data, it could be used at first or instead for generating more refined models for each access point. Position information and/or refined model data could then be provided to mobile terminal 502. (action 370)

Alternatively, the retrieved data could be provided to another server or to mobile terminal 502. The other server or mobile terminal 502 could then store the received data and/or generate refined model data and/or determine the position of mobile terminal 502 for use by some application based on the received data. It is furthermore to be understood that the request does not have to be received from a mobile terminal, it could also be received from another server. If received from a server, the included BSSIDs and (optionally) MCC do not have to be based on measurements.

It is to be understood that all or a part of actions 352 to 370 could also be realized at mobile terminal 502, for instance if mobile terminal 502 stores a database with information about WLAN access points for being able to perform an independent positioning. In this case, BSSIDs and (optionally) other data do not have to be received in a message. Instead, they could be received internally, for instance from an integrated WLAN receiver and an integrated cellular receiver.

Summarized, certain embodiments of the invention may have the effect of facilitating the use of information about multiple WLAN access points with the same identifier in different regions.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 301 in combination with memory 102 or 302, respectively, or the integrated circuit 305 can also be viewed as means for receiving an identifier of an access point of a wireless local area network and additional information about the access point; means for receiving data which enables a determination of an identifier of a region in which the access point is assumed to be located; and means for causing a storage of information that is based on the additional information in a database such that it is assigned to the identifier of the access point as a primary key and to the identifier of the region as a secondary key.

The program codes in memory 102 and 302, respectively, can also be viewed as comprising such means in the form of functional modules.

The functions illustrated by processor 201 or 301 in combination with memory 202 or 302, respectively, or the integrated circuit 305 can also be viewed as means for receiving an identifier of an access point of a wireless local area network; means for determining an identifier of a region in which the access point is assumed to be located; and means for retrieving from a database further information about the access point that is stored with an assignment to the identifier of the access point as a primary key and to the identifier of the region as a secondary key.

The program codes in memory 202 and 302, respectively, can also be viewed as comprising such means in the form of functional modules.

FIGS. 2, 4, 6 and 8 may also be understood to represent exemplary functional blocks of computer program codes supporting the use of information about WLAN access points.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-25. (canceled)

26. A method comprising:
receiving, by an apparatus, an identifier of an access point of a wireless local area network and additional information about the access point;
receiving, by the apparatus, data which enables a determination of an identifier of a region in which the access point is assumed to be located; and
causing, by the apparatus, a storage of information that is based on the additional information in a database such that it is assigned to the identifier of the access point as a primary key and to the identifier of the region as a secondary key.

27. The method according to claim 26, wherein the identifier of the access point comprises a basic service set identification, and wherein the identifier of a region comprises a mobile country code.

28. The method according to claim 26, wherein the identifier of the region is determined based on one of:
a mobile country code received, by the apparatus, from a mobile device along with data on which the additional information about the access point is based;
a mobile country code received, by the apparatus, from a database along with data on which the additional information about the access point is based;
an indication of a position of a mobile device received, by the apparatus, from a mobile device along with data on which the additional information about the access point is based; and
an indication of a position received, by the apparatus, from a database along with data on which the additional information about the access point is based.

29. The method according to claim 26, wherein in case the database comprises previously stored information about an access point that is assigned to the received identifier of an access point as a primary key but only to a different identifier of a region as a secondary key than would be determined based on the received data, the method further comprising:
in case the previously stored information about an access point comprises location information that identifies a location within a predetermined distance to a location of an access point identified by the received additional information, combining, by the apparatus, information that is based on the received additional information with the previously stored information and one of storing the combined information such that it is assigned to one of the identifiers of a region as a secondary key and storing the combined information such that it is assigned to each of the identifiers of a region as a respective secondary key; and
otherwise storing, by the apparatus, information that is based on the received additional information separately such that it is assigned to the received identifier of an access point as a primary key and to the determined identifier of a region as a secondary key.

30. The method according to claim 26, wherein the information that is based on the additional information about the access point comprises at least one of:
coordinates of locations at which signals from the access point can be received;
results of signal strength measurements on signals from the access point at a mobile device;
data of a signal strength grid;
model data for the access point;
data indicating coordinates of the access point;
data indicating a coverage area of the access point; and
parameters of a radio propagation model for the access point.

31. A method comprising:
receiving, by an apparatus, an identifier of an access point of a wireless local area network;
determining, by the apparatus, an identifier of a region in which the access point is assumed to be located; and
retrieving, by the apparatus, from a database further information about the access point that is stored with an assignment to the identifier of the access point as a primary key and to the identifier of the region as a secondary key.

32. The method according to claim 31, wherein the identifier of the region is determined based on at least one of:
at least one mobile country code;
an identifier of a region determined by a mobile device in cellular measurements and received by the apparatus;
an identifier of a region determined by a mobile device from signals from at least one access point of a wireless local area network and received by the apparatus; and
at least one identifier of a region that is used as a secondary key in the database.

33. The method according to claim 31, wherein the identifier of the access point comprises a basic service set identification and wherein the retrieved information about the access point comprises at least one of:
coordinates of locations at which signals from the access point can be received;
results of signal strength measurements on signals from the access point at a mobile device;
data of a signal strength grid;
model data for the access point;
data indicating coordinates of the access point;
data indicating a coverage area of the access point; and
parameters of a radio propagation model for the access point.

34. An apparatus comprising at least one processor and at least one memory including computer program code, the at least one memory and the computer program code configured to, with the at least one processor, cause an apparatus at least to perform:
receive an identifier of an access point of a wireless local area network and additional information about the access point;
receive data which enables a determination of an identifier of a region in which the access point is assumed to be located; and
cause a storage of information that is based on the additional information in a database such that it is assigned to the identifier of the access point as a primary key and to the identifier of the region as a secondary key.

35. The apparatus according to claim 34, wherein the identifier of the access point comprises a basic service set identification, and wherein the identifier of a region comprises a mobile country code.

36. The apparatus according to claim 34, wherein the computer program code is configured to, with the at least one processor, cause the apparatus to determine the identifier of the region based on one of:
a mobile country code received, by the apparatus, from a mobile device along with data on which the additional information about the access point is based;
a mobile country code received, by the apparatus, from a database along with data on which the additional information about the access point is based;
an indication of a position of a mobile device received, by the apparatus, from a mobile device along with data on which the additional information about the access point is based; and
an indication of a position received, by the apparatus, from a database along with data on which the additional information about the access point is based.

37. The apparatus according to claim 34, wherein for the case the database comprises previously stored information about an access point that is assigned to the received identifier of an access point as a primary key but only to a different identifier of a region as a secondary key than would be determined based on the received data, the computer program code is configured to, with the at least one processor, cause the apparatus to:
combine information that is based on the received additional information with the previously stored information and one of store the combined information such that it is assigned to one of the identifiers of a region as a secondary key and store the combined information such that it is assigned to each of the identifiers of a region as a respective secondary key, in case the previously stored information about an access point comprises location information that identifies a location within a predetermined distance to a location of an access point identified by the received additional information; and
otherwise store information that is based on the received additional information separately such that it is assigned to the received identifier of an access point as a primary key and to the determined identifier of a region as a secondary key.

38. The apparatus according to claim 34, wherein the information that is based on the additional information about the access point comprises at least one of:
coordinates of locations at which signals from the access point can be received;
results of signal strength measurements on signals from the access point at a mobile device;
data of a signal strength grid;
model data for the access point;
data indicating coordinates of the access point;
data indicating a coverage area of the access point; and
parameters of a radio propagation model for the access point.

39. The apparatus according to claim 34, wherein the apparatus is one of:
a server;
a component for a server;
a mobile device; and
a component for a mobile device.

40. An apparatus comprising at least one processor and at least one memory including computer program code, the at least one memory and the computer program code configured to, with the at least one processor, cause an apparatus at least to perform:
receive an identifier of an access point of a wireless local area network;
determine an identifier of a region in which the access point is assumed to be located; and
retrieve from a database further information about the access point that is stored with an assignment to the identifier of the access point as a primary key and to the identifier of the region as a secondary key.

41. The apparatus according to claim 40, wherein the computer program code is configured to, with the at least one processor, cause the apparatus to determine the identifier of the region based on at least one of:
at least one mobile country code;
an identifier of a region determined by a mobile device in cellular measurements and received by the apparatus;
an identifier of a region determined by a mobile device from signals from at least one access point of a wireless local area network and received by the apparatus; and
at least one identifier of a region that is used as a secondary key in the database.

42. The apparatus according to claim 40, wherein the identifier of the access point comprises a basic service set identification and wherein the retrieved information about the access point comprises at least one of:
coordinates of locations at which signals from the access point can be received;
results of signal strength measurements on signals from the access point at a mobile device;
data of a signal strength grid;
model data for the access point;
data indicating coordinates of the access point;
data indicating a coverage area of the access point; and
parameters of a radio propagation model for the access point.

43. The apparatus according to claim 40, wherein the apparatus is one of:
a server;
a component for a server;
a mobile device; and
a component for a mobile device.
